(19) United States
(12) Patent Application Publication
(10) Pub. No.: US 2018/0050891 A1
(43) Pub. Date: Feb. 22, 2018

(54) UNDERCARRIAGE FOR A VEHICLE CRANE AND VEHICLE CRANE COMPRISING SUCH AN UNDERCARRIAGE

(71) Applicant: TEREX CRANES GERMANY GMBH, Zweibrücken (DE)

(72) Inventors: Benjamin Schaal, Zweibrücken (DE); Thorsten Helwes, Homburg (DE); Fritz-Botho Köster, Rockenhausen (DE); Klaus Meissner, Zweibrücken (DE); Alfons Weckbecker, Zweibrücken (DE); Frank Schnittker, Würzburg (DE)

(21) Appl. No.: 15/553,834

(22) PCT Filed: Mar. 14, 2016
(86) PCT No.: PCT/EP2016/055428

§ 371 Date: Aug. 25, 2017

(30) Foreign Application Priority Data
Mar. 19, 2015 (DE) 10 2015 205 008.4

(51) Int. Cl. B66C 23/78; B66C 23/36

(52) U.S. Cl. CPC B66C 23/78; B66C 23/36

(57) ABSTRACT

An undercarriage for a vehicle crane includes multiple supports that are pivotably articulated on the chassis between a working arrangement and a transport arrangement, and includes a rotary joint component for the rotatable connection of a superstructure to the undercarriage, with the rotary joint component determining a transport height of the undercarriage, which completely uses a maximum admissible transport height.

### CROSS REFERENCE TO RELATED APPLICATIONS

The present patent application claims the priority benefits of International Patent Application No. PCT/EP2016/055428, filed Mar. 14, 2016, and claims benefit of German patent application DE 10 2015 205 008.4, filed on Mar. 19, 2015, the contents of which are incorporated herein by reference.

### BACKGROUND OF THE INVENTION

The invention relates to an undercarriage for a vehicle crane and to a vehicle crane comprising such an undercarriage.

EP 1 541 520 B1 discloses a vehicle crane, in which a travelling mechanism together with supports mounted thereon completely utilize a maximum permitted transport height.

### SUMMARY OF THE INVENTION

The object of the present invention is to provide a vehicle crane which has improved transport and/or assembly properties.

In accordance with an embodiment of the invention, it has been recognised that a rotary connection component is arranged on the undercarriage such that the rotary connection component determines a transport height of the undercarriage. The rotary connection component is arranged on an upper side of the undercarriage. The rotary connection component forms the upper termination of the undercarriage. The transport height completely utilizes a maximum permitted transport height. In Germany, the road traffic act (StVZO) stipulates a maximum permitted transport height of 4.0 m on roads. The maximum permitted transport height may be different in dependence upon national regulations. Furthermore, the undercarriage has a plurality of supports which are articulated to the undercarriage so as to be able to pivot between a working arrangement and a transport arrangement. The supports are arranged below the rotary connection component. The rotary connection component serves to rotatably connect a superstructure to the undercarriage. The rotary connection component is connected to the undercarriage in particular in a detachable manner. The rotary connection component remains on the undercarriage in the transport state. In accordance with the invention, it has been recognised that the assembly of the vehicle crane is simplified by virtue of the, in particular permanent, arrangement of the rotary connection on the undercarriage. The undercarriage, which in particular is designed to be automotive, i.e. as a vehicle, is transported autonomously to a work site. A superstructure which can be arranged thereon is transported to the work site independently of the undercarriage. At the work site, the superstructure is attached to the superstructure, e.g. by means of an auxiliary crane. In this respect, it is acceptable that the supports do not utilize the maximum permitted transport height of the undercarriage.

An undercarriage, in which the supports each determine a support height which amounts at most to 80% of the maximum permitted transport height, permits sufficient installation space height for the rotary connection component. In particular, the support height amounts at most to 85% of the maximum permitted transport height and in particular amounts at most to 90% of the maximum permitted transport height.

An undercarriage, in which the rotary connection component can be connected directly to the superstructure or to a mating rotary connection component fastened to the superstructure, permits simplified assembly of the superstructure on the undercarriage. It is possible that the rotary connection component mounted on the undercarriage is designed e.g. as a complete roller rotary connection. In this case, the rotary connection component arranged on the undercarriage is a complete rotary connection. The superstructure is then directly attached and connected to the rotary connection component designed as a rotary connection. The rotary connection is not divided, i.e. is in one piece, and is designed in particular such that it cannot be divided. Alternatively, the rotary connection component arranged on the undercarriage can cooperate with the mating rotary connection component fastened to the superstructure such that as a result a rotary connection, in particular in the form of a roller rotary connection, is produced. This means that the roller rotary connection is arranged in part on the undercarriage and in part on the superstructure. The rotary connection is designed such that it can be divided and comprises the rotary connection component arranged on the undercarriage and the mating rotary connection component arranged on the superstructure. In this alternative embodiment, the installation space height of the rotary connection component is reduced. The support height can be increased without the maximum permitted transport height being exceeded.

An undercarriage, in which the supports are a component part of an undercarriage frame, has improved rigidity. The support of the undercarriage in the working arrangement is reliable and stable.

An undercarriage, in which four supports are provided, permits reliable support, in particular by means of a square support base. The four supports are arranged in particular in a rotationally symmetrical manner in relation to an axis of rotation of the rotary connection component. The four supports are arranged on the undercarriage in particular in the region of the rotary connection component.

An undercarriage comprising an undercarriage pot permits a robust connection of the rotary connection component to the undercarriage. The undercarriage is designed having a lightweight construction. In particular, the undercarriage pot is of hollow-cylindrical design. The undercarriage pot has a high level of structural stability. The undercarriage pot can be of conical design, in particular in relation to the axis of rotation of the rotary connection component. A conicity angle with respect to the axis of rotation amounts at most to 20°, in particular at most to 15°, in particular at most to 10°, in particular at most to 7°, in particular at most to 5° and in particular at most to 3°. The rotary connection component is arranged in particular directly on the undercarriage pot and is connected thereto.

An undercarriage, in which the supports are fastened to the undercarriage pot permits an improved introduction of force and transmission of force into the supports. The support of the undercarriage on the ground is improved.

An undercarriage, in which at least one of the supports is telescopic allows the size of the support surface to be increased in an uncomplicated manner. In particular, the size of the support surface can be adapted to local conditions at the work site. In particular, it is possible to select an optimum size of the support surface such that the support surface is selected to be as large as possible in order to provide the largest possible support surface, and at the same time spatial restrictions at the work site, e.g. caused by surrounding buildings, are taken into consideration.

A vehicle crane comprising an undercarriage in accordance with the invention and comprising a superstructure which is arranged rotatably thereon has substantially the advantages of the undercarriage in accordance with the invention, to which reference is hereby made.

A further object of the present invention is to provide a vehicle crane having improved transport and assembly properties.

In accordance with another embodiment of the invention, it has been recognised that an undercarriage comprising a travelling mechanism and supports mounted thereon can be transported in an uncomplicated manner if a rotary connection component of the rotary connection determines a transport height of the undercarriage which completely utilizes a maximum permitted transport height. Therefore, it is accepted that the supports alone do not completely utilize the maximum permitted transport height. As a result, the rotary connection component can be arranged on the undercarriage. The assembly of the vehicle crane is simplified. The vehicle crane further comprises a rotary stage having a crane structure which can be constructed thereon, wherein the rotary connection serves to rotatably connect the rotary stage on the undercarriage. The supports are arranged on the undercarriage so as to be displaceable from a folded-up transport position to a folded-out working position. The undercarriage has four supports which are mounted such that they can be pivoted-out on the travelling mechanism. The four supports are telescopic along their length. The articulation points of the supports are located in the central region of the travelling mechanism so that free ends of the supports in the transport position are each directed in the direction of a driver's cab and/or in the direction of a vehicle rear end. In particular, the supports in the transport position are oriented in parallel with the direction of travel of the vehicle crane. The phrase “in the central region of the travelling mechanism” means that the articulation points of the supports are arranged approximately centrally in relation to the vehicle length of the vehicle crane in the direction of travel. In particular, two articulation points are each arranged in the direction of travel in pairs symmetrically on the undercarriage. In particular, the axis of rotation of the rotary connection is arranged in the central region of the travelling mechanism. The central region is understood to be an extension, starting from the central point as seen in the direction of the vehicle length, of at least 5% of the vehicle length in the direction of travel and in the direction opposite to the direction of travel, i.e. in the direction of the driver's cab and in the direction of the vehicle rear end. In particular, this two-sided extension amounts in each case to at least 10% of the vehicle length, in particular to at least 15% of the vehicle length, in particular to at least 20% of the vehicle length and in particular to at most 30% of the vehicle length.

An exemplified embodiment of the invention is explained in greater detail hereinafter with reference to the drawings.

### BRIEF DESCRIPTION OF THE DRAWINGS

FIG. 1 shows a perspective view of a vehicle crane comprising an undercarriage in accordance with the invention and a schematically illustrated rotary stage arranged thereon, and

FIG. 2 shows a side view of the undercarriage shown in FIG. 1 in a transport arrangement.

### DESCRIPTION OF THE PREFERRED EMBODIMENTS

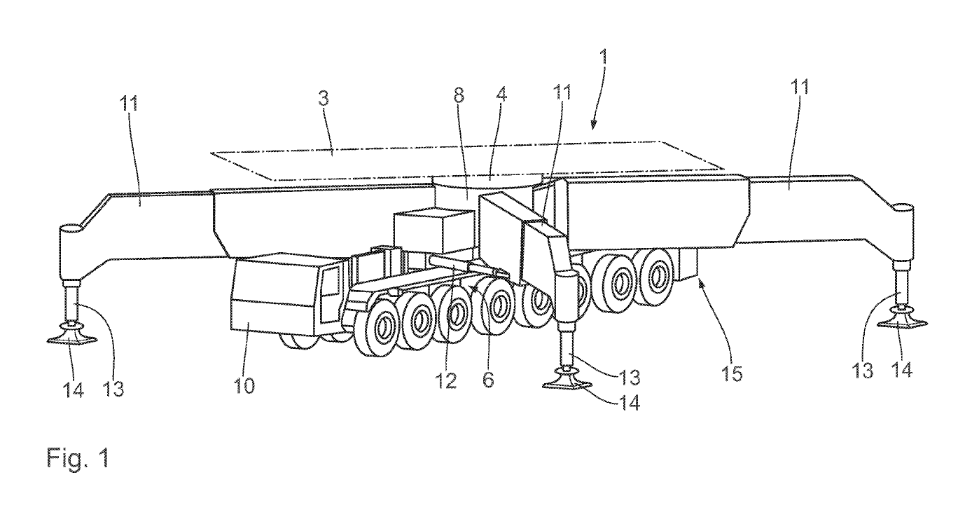

FIG. 1 illustrates a vehicle crane, which is designated as a whole by the reference numeral 1, in a working arrangement. The vehicle crane 1 has an undercarriage 2 and a rotary stage 3 arranged so as to be rotatable with the undercarriage 2. The rotatable connection between the undercarriage 2 and the rotary stage 3 is effected by means of a rotary connection 4. The rotary connection 4 permits a rotation about an axis of rotation 5 oriented in particular vertically.

A crane structure can be constructed on the rotary stage 3. The crane structure is not illustrated in FIG. 1. The crane structure can be designed as a telescoping jib. The crane structure can also be a luffable lattice mast jib. The crane structure can comprise a counterweight arrangement which rotates with the rotary stage 3 about the axis of rotation 5. The crane structure can also have an operator's cab which can accommodate a person operating the crane structure during operation of the crane structure. Operating elements can be arranged in the operator's cab. The rotary stage 3 together with the crane structure, not illustrated in greater detail, form a superstructure.

According to the exemplified embodiment shown, the rotary connection 4 is designed such that it cannot be divided. The rotary connection 4 is firmly connected to the undercarriage 2. The superstructure, in particular the rotary stage 3, is attached directly onto the rotary connection 4 in order to be rotatably connected to the undercarriage 2. The rotary connection 4 comprises at least one rotary connection component. According to the exemplified embodiment shown, the rotary connection 4 consists exclusively of the rotary connection component. It is alternatively possible that the rotary connection 4 is designed such that it can be divided and has a rotary connection component arranged on the undercarriage 2 and has a mating rotary connection component corresponding thereto and arranged on the superstructure.

The undercarriage 2 can be driven autonomously and has an undercarriage drive. The undercarriage drive can be a diesel engine. Alternative, in particular hybrid, concepts for the undercarriage drive are also possible. The undercarriage 2 has a travelling mechanism 6, on which a plurality of vehicle axles 7, eight vehicle axles according to the exemplified embodiment shown, are arranged. At least one of the vehicle axles 7 is driven by means of the traction drive, not illustrated. In particular, all of the vehicle axles 7 are driven. At least one wheel set which is arranged on the vehicle axle 7 is steerable. A plurality, in particular all, of the wheel sets can also be designed to be steerable. An undercarriage pot 8 is connected directly to the travelling mechanism 6. The undercarriage pot 8 is of substantially hollow-cylindrical design and is arranged coaxially with respect to the axis of rotation 5. The undercarriage pot 8 is arranged on the horizontally oriented, frame-like travelling mechanism 6. The frame-like travelling mechanism 6 constitutes an undercarriage frame.

The vehicle crane 1 has a vehicle length L which is determined in particular by the undercarriage 2. The vehicle length L is oriented in parallel with the direction of travel 9 of the vehicle crane 1. A driver's cab 10 is arranged on the undercarriage 2 at the front in the direction of travel 9. In relation to the vehicle length L, the undercarriage pot 8 and thus the axis of rotation 5 of the rotary connection 4 are arranged in a central region.

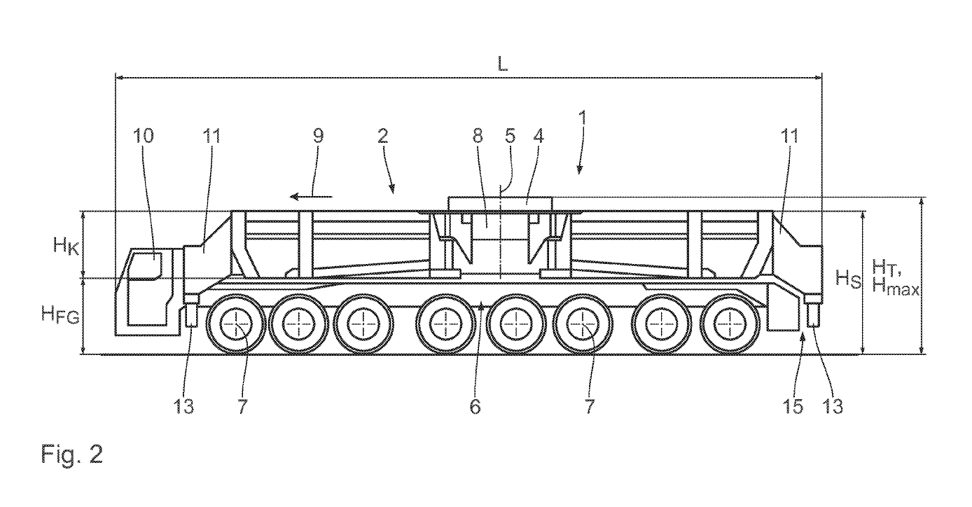

The undercarriage 2 has four supports 11 which are articulated to the undercarriage 2 so as to be able to pivot between the working arrangement in FIG. 1 and the transport arrangement in FIG. 2. The supports 11 are fastened directly to the undercarriage pot 8. The supports 11 are telescopic in relation to their length, i.e. in a radial direction in relation to the axis of rotation 5. The articulation points of the supports 11 are arranged in the central region of the travelling mechanism 6. In order to pivot the supports 11, a drivable actuator, in particular a hydraulic cylinder 12, is provided in each case. The actuator can also be designed as a pneumatic cylinder or as a spindle drive. The pivot axis of the respective support 11 is vertically oriented.

In the working arrangement, the supports 11 are arranged equally spaced apart from one another about the axis of rotation 5 in relation to an angle of rotation. An intermediate angle between two adjacent supports 11 amounts to 90°.

The respective free ends of the supports 11 are provided with vertically acting support cylinders 13 each having a support plate 14. The support cylinders 13 each form corner points of the support surface of the vehicle crane 1. According to the working arrangement in FIG. 1, the support cylinders 13 form a square support surface. It is also possible to modify the corner points and thus the support surface by means of a modified angle arrangement of the supports 11 with respect to one another and/or by modifying the support length by telescoping the supports 11.

In the transport arrangement shown in FIG. 2, the supports 11 are folded-up on the undercarriage 2. The supports 11 facing the driver's cab 10 on the undercarriage pot 8 are directed in the direction of travel 9, i.e. in the direction of the driver's cab 10. With the supports 11 telescoped one inside the other, the length of the supports is such that the free end of the supports 11 is arranged behind the driver's cab 10. In the transport arrangement, the supports 11 arranged on the undercarriage 8 to be facing away from the driver's cab 10 are directed in the direction opposite the direction of travel 9, i.e. in the direction of a vehicle rear end 15. In the transport arrangement, all of the supports 11 are oriented in parallel with one another. In the transport arrangement, the support plates 14 are separated from the support cylinders 13. The support plates 14 are transported separately from the support cylinders 13, in particular in a storage space provided on the undercarriage 2 for this purpose.

The rotary connection component which is arranged on the undercarriage 2 and, according to the exemplified embodiment shown, is produced by means of the rotary connection 4 determines a transport height H_{T} of the undercarriage 2.

The transport height H_{T} of the undercarriage 2 completely utilizes the maximum permitted transport height Hₘₐₓ. According to the exemplified embodiment shown, the maximum permitted transport height Hₘₐₓ is identical to the transport height H_{T} of the undercarriage 2. In particular, the transport height H_{T} amounts to 4.0 m. Complete utilization of the maximum permitted transport height Hₘₐₓ is also achieved in terms of the present patent application when the transport height H_{T} of the undercarriage 2 is slightly less than the maximum permitted transport height Hₘₐₓ and in particular amounts to at least 97% of the maximum permitted transport height Hₘₐₓ, in particular to at least 98% of the maximum permitted transport height Hₘₐₓ, in particular to at least 99% of the maximum permitted transport height Hₘₐₓ and in particular to 99.5% of the maximum permitted transport height Hₘₐₓ. It is essential that the supports 11 together with the travelling mechanism 6 do not completely utilize the maximum permitted transport height Hₘₐₓ.

The supports 11 each determine a support height H_{S} which is less than the maximum permitted transport height Hₘₐₓ. The support height H_{S} of the supports 11 includes the height of the supports 11 arranged on the travelling mechanism 6. According to the exemplified embodiment shown in FIG. 2, the support height H_{S} is calculated by addition of a support box height H_{K} and a travelling mechanism height H_{FG}. It is also feasible to have embodiments of the travelling mechanism 6 and/or supports 11 such that the support box height H_{K} and the travelling mechanism height H_{FG} overlap. According to the exemplified embodiment shown, the support height H_{S} amounts to 80% of the maximum permitted transport height Hₘₐₓ. According to the exemplified embodiment shown, the support box height H_{K} amounts to approximately half the support height H_{S}. The support box height H_{K} is of crucial importance for the area moment of inertia of the support box profile of the supports 11. The support box height H_{K} cubed is included in the area moment of inertia. The greater the support height H_{S} can be selected, the greater the support box height H_{K} can be selected. The travelling mechanism height H_{FG} is predetermined by reason of the tyre size which is determined in particular by a permitted maximum weight.

1. An undercarriage for a vehicle crane, comprising:
a plurality of supports which are articulated to the undercarriage so as to be able to pivot between a working arrangement and a transport arrangement; and
a rotary connection component configured to rotatably connect a superstructure to the undercarriage;
wherein the rotary connection component determines a transport height of the undercarriage, and
wherein the transport height completely utilizes a maximum permitted transport height.

2. The undercarriage as claimed in claim 1, wherein the supports each determine a support height which amounts at most to 80% of the maximum permitted transport height.

3. The undercarriage as claimed in claim 1, wherein the rotary connection component can be connected directly to the superstructure or to a mating rotary connection component fastened to the superstructure.

4. The undercarriage as claimed in claim 3, wherein the supports are a component part of the undercarriage frame.

5. The undercarriage as claimed in claim 4, wherein four supports are provided which are arranged in a rotationally symmetrical manner in relation to an axis of rotation of the rotary connection component, in particular in the region of the rotary connection component.

6. The undercarriage as claimed in claim 5, further comprising an undercarriage pot, on which the rotary connection component is arranged.

7. The undercarriage as claimed in claim 6, wherein the supports are fastened to the undercarriage pot.

8. The undercarriage as claimed in claim 7, wherein at least one of the supports is telescopic.

9. (canceled)

10. (canceled)

11. The undercarriage as claimed in claim 2, wherein the supports each determine a support height which amounts at most to 85% of the maximum permitted transport height.

12. The undercarriage as claimed in claim 11, wherein the supports each determine a support height which amounts at most to 90% of the maximum permitted transport height.

13. The undercarriage as claimed in claim 1, wherein the supports are a component part of the undercarriage frame.

14. The undercarriage as claimed in claim 13, wherein four supports are provided which are arranged in a rotationally symmetrical manner in relation to an axis of rotation of the rotary connection component in the region of the rotary connection component.

15. The undercarriage as claimed in claim 1, wherein four supports are provided which are arranged in a rotationally symmetrical manner in relation to an axis of rotation of the rotary connection component.

16. The undercarriage as claimed in claim 1, further comprising an undercarriage pot, on which the rotary connection component is arranged.

17. The undercarriage as claimed in claim 16, wherein the supports are fastened to the undercarriage pot.

18. The undercarriage as claimed in claim 1, wherein at least one of the supports is telescopic.

19. The undercarriage as claimed in claim 18, wherein all of the supports are telescopic.

20. A vehicle crane, said vehicle crane comprising:
a superstructure; and
an undercarriage having a plurality of supports which are articulated to the undercarriage so as to be able to pivot between a working arrangement and a transport arrangement, said undercarriage further including a rotary connection component with said superstructure being rotatably connected to the undercarriage via the rotary connection component;
wherein the rotary connection component determines a transport height of the undercarriage, and wherein the transport height completely utilizes a maximum permitted transport height.

21. The vehicle crane of claim 20, wherein the supports amount at most to between 80% to 90% of the maximum permitted transport height.

22. A vehicle crane, said vehicle crane comprising:
an undercarriage comprising a travelling mechanism and supports mounted thereon;
a rotary stage with a crane structure which can be constructed thereon; and
a rotary connection for rotatably connecting the rotary stage on the undercarriage;
wherein the supports are displaceable from a folded-up transport position to a folded-out working position, the undercarriage has four supports which are mounted such that they can be pivoted-out on its travelling mechanism and the four supports are telescopic along their length, and wherein articulation points of the supports are located in the central region of the travelling mechanism so that in each case free ends of the supports in the transport position are each directed in the direction of a driver's cab and/or in the direction of a vehicle rear end, and wherein a rotary connection component of the rotary connection determines a transport height of the undercarriage and the transport height completely utilizes a maximum permitted transport height.
